(19) United States
(12) Patent Application Publication
(10) Pub. No.: US 2008/0304503 A1
(43) Pub. Date: Dec. 11, 2008

(54) TRAFFIC MANAGER AND METHOD FOR PERFORMING ACTIVE QUEUE MANAGEMENT OF DISCARD-ELIGIBLE TRAFFIC

(76) Inventor: Steven Langley Blake, Cary, NC (US)

Correspondence Address: ERICSSON INC., 6300 LEGACY DRIVE, M/S EVR 1-C-11, PLANO, TX, 75024, US

(21) Appl. No.: 11/758,069

(22) Filed: Jun. 5, 2007

(51) Int. Cl. H04L 12/28; G08C 15/00

(52) U.S. Cl. 370/412; 370/235.1

(57) ABSTRACT

A traffic manager and a method are described herein that are capable of performing an active queue management of discard-eligible traffic for a shared memory device (with a per-CoS switching fabric) that provides fair per-class backpressure indications.

### TECHNICAL FIELD

The present invention relates to a traffic manager and method for performing active queue management of discard-eligible traffic for a shared memory device (with a per-CoS switching fabric) that provides fair per-class backpressure indications.

### BACKGROUND

The following abbreviations are herewith defined, at least some of which are referred to within the ensuing description of the prior art and the present invention.

### AIAD Additive Increase/Additive Decrease

### AIMD Additive Increase/Multiplicative Decrease

### AQM Active Queue Management

### CIR Committed Information Rate

### CoS Class of Service

### DE Discard Eligible

### EIR Excess Information Rate

### FIFO First-In First-Out

### HOL Head-Of-Line

### RED Random Early Discard

### TM Traffic Manager

### VOQ Virtual Output Queue

Referring to FIG. 1 (PRIOR ART), there is a block diagram illustrating the basic components of a traditional fabric switching system 100. As shown, the traditional fabric switching system 100 includes a multi-port shared memory switching device 102, multiple ingress traffic managers 104 and multiple egress traffic managers 106. The shared memory switching device 102 has multiple switch input ports 108 (connected to the ingress traffic managers 104), a core 110 (with a per-flow switching fabric 112a or a per-CoS switching fabric 112b), multiple output port queues 114 and multiple switch output ports 116 (connected to the egress traffic managers 106)(note: a flow is defined herein as an aggregate of traffic from a particular switch input port 108 to a particular switch output port 116 at a particular CoS). Each ingress TM 104 has multiple virtual output queue (VOQ) schedulers 118 which schedule either per-fabric output port/per-flow queues 120 (see FIG. 2) or per-fabric output port/per-CoS queues 120 (see FIG. 3) to prevent head-of-line (HOL) blocking to the shared memory switching device 102. And, each VOQ 120 corresponds with one of the output port queues 114 in the shared memory switching device 102. Thus, the shared memory switching device 102 can send a backpressure indication to one or more of the VOQ schedulers 118 when a particular output port queue 114 is congested. In the case of a per-flow switching fabric 112a, an output port queue 114 is associated uniquely to a single ingress TM VOQ 120 at a single ingress TM 104, while in the case of a per-CoS switching fabric 112b, an output port queue 114 is associated uniquely with an ingress TM VOQ 120 at each ingress TM 104. Upon receiving a backpressure indication, the VOQ scheduler 118 reduces the rate of traffic submission from the associated VOQ 120 to the shared memory switching device 102. In particular, the VOQ scheduler 118 is suppose to reduce the rate of traffic submission in accordance with a fabric-specific protocol that takes into account the buffer capacity of the shared memory switching device 102 and the round-trip latency through the shared memory switching device 102. If all of the ingress TMs 104 behave in accordance with this fabric-specific protocol, then packet/cell loss within the shared memory switching device 102 could be eliminated, and traffic discard for extreme congestion conditions in the core 110 can be managed at each ingress TM 104 (where it may be more feasible to provide large buffering capacity). However, not all ingress TMs 104 can effectively do this when the shared memory switching device 102 has the per-CoS switching fabric 112b. This is because the per-CoS output queues 114 are not each associated with a single TM VOQ 120 at a single ingress TM 104.

Typically class of services are defined which guarantee a committed information rate (CIR) for traffic between node input and output ports (which by necessity cross a particular fabric input/output port pair 108 and 116), while allowing excess traffic (up to some limit) to be switched whenever the shared memory switching device 102 has sufficient capacity (i.e., when some source of committed traffic is not transmitting at its committed rate). The committed traffic rate is defined such that the shared memory switching device 102 can transmit the maximum committed traffic from input/output port pairs 108 and 116, without congestion, in the absence of excess traffic. The excess traffic can be treated as discard-eligible (DE) traffic which should be discarded in the event of congestion to preserve the capacity that the shared memory switching device 102 has for the committed traffic. In practice, the matrix of committed traffic is not uniform which is not problematical when the shared memory switching device 102 has the per-flow switching fabric 112a (see FIG. 2) but could be problematical when the shared memory switching device 102 has the per-CoS switching fabric 112b (see FIG. 3).

Referring to FIG. 2 (PRIOR ART), there is a block diagram of the traditional fabric switching system 100 which is used to help explain how non-uniform committed traffic can be properly handled when the shared memory switching device 102 has a per-flow switching fabric 112a. In this example, assume that at fabric input port A, the CIR and excess information rate (EIR) to the fabric output port C is 5/6*Rout (where Rout is the fabric output port rate excluding fabric-specific overheads). At fabric input port B, the CIR for fabric output port C is 1/6*Rout, while the EIR is 5/6*Rout. Thus, the sum total of the committed and excess rates for the fabric output port C exceeds Rout. Because, the per-flow switching fabric 112a often supports non-fair flow scheduling and backpressure per-output port/per-flow (without DE awareness) it is able to ensure that each flow is serviced at a rate which is no less than its committed rate. As shown, the two flows are represented as A->C and B->C, with flow A->C scheduled with a minimum rate of 5/6*Rout, while flow B->C is scheduled with minimum rate of 1/6*Rout. In this example, congestion can only be caused by DE traffic for flow B->C at fabric input port B because the EIR of flow A->C is equal to the CIR. In the event of congestion, the output port queue 114 at fabric output port B sends a backpressure indication 202 for flow B->C to the ingress TM 104 at fabric input port B. Upon receiving the backpressure indication 202, the ingress TM 104 uses well known and relatively simple mechanisms to discard DE traffic at input port B to address the problematical congestion. This is all fine but per-flow switching fabrics 112a are often proprietary, typically expensive (relative to per-CoS switching fabrics 112b), and have scalability limitations in terms of the number of flows supported. As such, the shared memory switching device 102 with per-CoS switching fabrics 112b are being used more often these days and are even becoming standardized (see Virtual Bridged Local Area Networks-Amendment 7: Congestion Management, Draft 0.1, IEEE P802.1au, Sep. 29, 2006—the contents of which are incorporated by reference herein). However, the shared memory switching device 102 with a per-CoS switching fabric 112b also has several drawbacks which are discussed next with respect to FIG. 3.

Referring to FIG. 3 (PRIOR ART), there is a block diagram of the traditional fabric switching system 100 which is used to help explain how non-uniform committed traffic may not be properly handled when the shared memory switching device 102 has a per-CoS switching fabric 112b. Using the same example, assume that at fabric input port A, the CIR and EIR to the fabric output port C is 5/6*Rout (where Rout is the fabric output port rate excluding fabric-specific overheads). At fabric input port B, the CIR for fabric output port C is 1/6*Rout, while the EIR is 5/6*Rout. Thus, the sum total of the committed and excess rates for the fabric output port C exceeds Rout. Because, the per-CoS switching fabric 112b has fair flow scheduling and backpressure which is fair per-input port 108 (without DE awareness) it is not able to ensure that each flow is serviced at a rate no less than its committed rate. In this example, the two flows are represented as A->C and B->C, with flow A->C scheduled with a minimum rate of 5/6*Rout, while flow B->C is scheduled with minimum rate of 1/6*Rout. Again, congestion can only be caused by DE traffic for flow B->C generated by fabric input port B because the EIR of flow A->C is equal to the CIR. In the event of congestion, the output port queue 114 at fabric output port B sends backpressure indications 302 to the ingress TMs 104 at fabric input ports A and B. The backpressure indications 302 are sent to both ingress TMs 104 because the per-CoS switching fabric 112b supports fair flow backpressure indications. Unfortunately, in this congested situation, the ingress TMs 104 do not have the necessary mechanisms needed to handle DE traffic and as a result this particular traffic flow example cannot be supported because the per-CoS switching fabric 112b would only be able to guarantee at most 1/2*Rout for output port C (which is under congestion) to each input port A and B. This does not satisfy the committed rates. Accordingly, there is a need for an ingress TM that can properly handle DE traffic upon receiving a fair backpressure indication from a shared memory switching device that has a per-CoS switching fabric. This need and other needs are satisfied by the traffic manager and method of present invention.

### SUMMARY

In one aspect, the present invention provides a traffic manager including a virtual output queue scheduler with a discard mechanism and a plurality of per-fabric output port/per-Class of Service queues that: (a) receive a traffic aggregate; (b) rate monitor the traffic aggregate; (c) mark a portion of packets in the traffic aggregate as discard-eligible packets whenever the monitored rate of the traffic aggregate exceeds a committed rate; (d) transmit packets and the discard-eligible packets within the traffic aggregate at a transmission rate that is greater than the committed rate towards a per-Class of Service switching fabric in a shared memory switching device; and (e) upon receiving a backpressure indication from the shared memory switching device, discard at least a fraction of the discard-eligible packets within the traffic aggregate to reduce the transmission rate of the traffic aggregate to the shared memory switching device.

In yet another aspect, the present invention provides a method for performing an active queue management of discard-eligible traffic within a traffic manager which has a virtual output queue scheduler, a discard mechanism and a plurality of per-fabric output port/per-Class of Service queues. The method includes the steps of: (a) receiving a traffic aggregate; (b) rate monitoring the traffic aggregate; (c) marking a portion of packets in the traffic aggregate as discard-eligible packets whenever the monitored rate of the traffic aggregate exceeds a committed rate; (d) transmitting packets and the discard-eligible packets within the traffic aggregate at a transmission rate that is greater than the committed rate towards a per-Class of Service switching fabric in a shared memory switching device; and (e) upon receiving a backpressure indication from the fabric switching system, discarding at least a fraction of the discard-eligible packets within the traffic aggregate to reduce the transmission rate of the traffic aggregate to the shared memory switching device.

In still yet another aspect, the present invention provides a fabric switching system including a shared memory switching device (which has a per-Class of Service switching fabric) and a plurality of traffic managers, where each traffic manager has a virtual output queue scheduler, a discard mechanism and a plurality of per-fabric output port/per-Class of Service queues, and where each traffic manager functions to: (a) receive a traffic aggregate; (b) rate monitor the traffic aggregate; (c) mark a portion of packets in the traffic aggregate as discard-eligible packets whenever the monitored rate of the traffic aggregate exceeds a committed rate; (d) transmit packets and the discard-eligible packets within the traffic aggregate at a transmission rate that is greater than the committed rate towards the shared memory switching device; and (e) upon receiving a backpressure indication from the fabric switching system, discard at least a fraction of the discard-eligible packets within the traffic aggregate to reduce the transmission rate of the traffic aggregate to the shared memory switching device.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a block diagram illustrating the basic components associated with a traditional fabric switching system;

FIG. 2 (PRIOR ART) is a block diagram of the traditional fabric switching system which is used to help explain how non-uniform committed traffic can be properly handled when a shared memory switching device incorporated therein has a per-flow switching fabric;

FIG. 3 (PRIOR ART) is a block diagram of the traditional fabric switching system which is used to help explain how non-uniform committed traffic may not be properly handled when the shared memory switching device has a per-CoS switching fabric;

FIG. 4 is a block diagram of an exemplary fabric switching system which is used to help explain how a new ingress traffic manager enables non-uniform committed traffic to be properly handled when the shared memory switching device has a per-CoS switching fabric in accordance with the present invention;

FIG. 5 is a flowchart illustrating the basic steps of a method for performing an active queue management of discard-eligible traffic within the new ingress traffic manager in accordance with the present invention;

FIG. 6 is a block diagram of an exemplary ingress TM which has a discard mechanism (in particular a probabilistic DE traffic dropper) that could be used to implement the method shown in FIG. 5 in accordance with a first embodiment of the present invention; and

FIG. 7 is a block diagram of an exemplary ingress TM which has a discard mechanism (in particular a DE traffic dropper and a virtual leaky bucket) that could be used to implement the method shown in FIG. 5 in accordance with a second embodiment of the present invention.

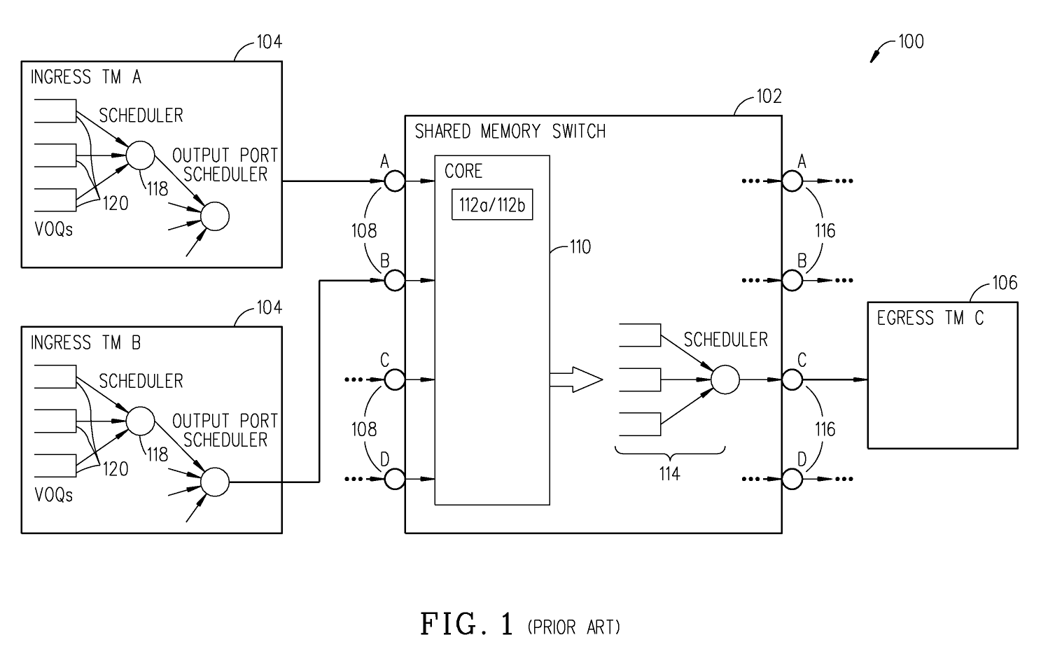

### DETAILED DESCRIPTION

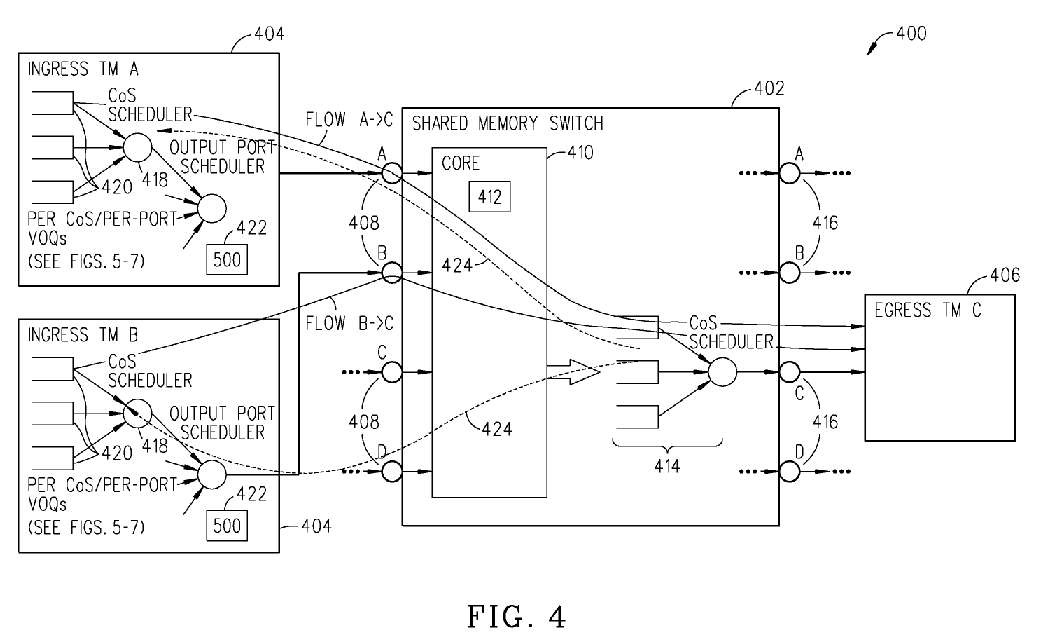

Referring to FIG. 4, there is a block diagram of an exemplary fabric switching system 400 which is used to help explain how a new ingress traffic manager 404 enables non-uniform committed traffic to be properly handled when a shared memory switching device 402 has a per-CoS switching fabric 412 in accordance with the present invention. As shown, the fabric switching system 400 includes a multi-port shared memory switching device 402, multiple ingress traffic managers 404 and multiple egress traffic managers 406. The shared memory switching device 402 has multiple switch input ports 408 (connected to the ingress traffic managers 404), a core 410 (with a per-CoS switching fabric 412), multiple output port queues 414 and multiple switch output ports 416 (connected to the egress traffic managers 406). Each ingress TM 404 has multiple virtual output queue (VOQ) schedulers 418 each of which schedule per-fabric output port/per-CoS queues 420 to prevent head-of-line (HOL) blocking to the shared memory switching device 402. And, each VOQ 420 corresponds with one of the output port queues 414 in the shared memory switching device 402. How the ingress TMs 404 enable non-uniform committed traffic to be properly handled when the shared memory switching device 402 has the per-CoS switching fabric 412 is described next.

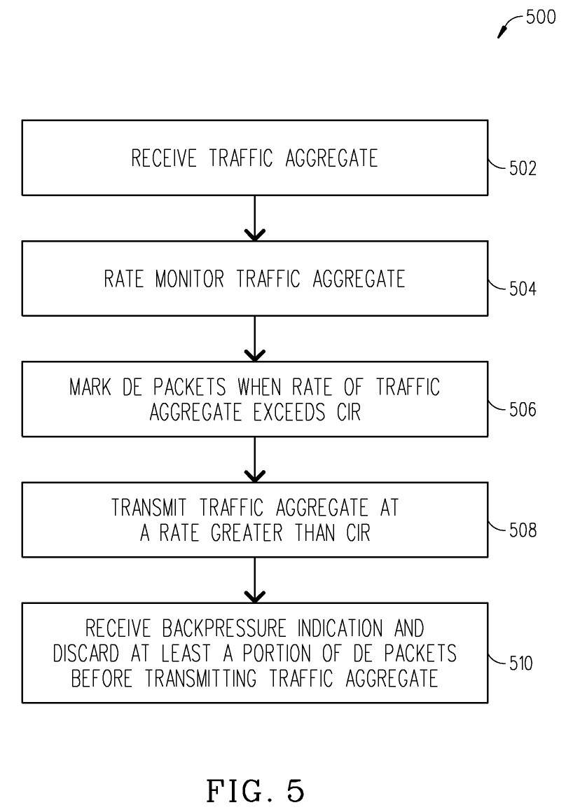

The basic concept of the present invention is to enable the ingress TMs 404 to reduce the rate of DE traffic transmitted from their VOQ schedulers 418 which have received a fair backpressure indication 424 from the shared memory switching device 402. To accomplish this, the ingress TMs 404 have a discard mechanism 422 which enables the steps in method 500 to be performed as follows: (a) receive a traffic aggregate (step 502 in FIG. 5); (b) rate monitor the traffic aggregate (step 504 in FIG. 5); (c) mark a portion of packets in the traffic aggregate as DE packets whenever a rate of the traffic aggregate exceeds a committed rate (step 506 in FIG. 5); (d) transmit packets and the DE packets within the traffic aggregate at a transmission rate that is greater than the committed rate towards the shared memory switching device 402 (step 508 in FIG. 5); and (e) upon receiving a backpressure indication 424 from the shared memory switching device 402, discard at least a fraction of the DE packets within the traffic aggregate to reduce the transmission rate of the traffic aggregate to the shared memory switching device 402 (step 510 in FIG. 5).

A detailed discussion is provided next to explain how the ingress TM 404 and the discard mechanism 422 can implement the method 500 to enable non-uniform committed traffic to be properly handled during congestion within the shared memory switching device 402. In the following discussion, several assumptions are made about the structure and capabilities of the exemplary fabric switching system 400. These assumptions are as follows:

1. Assume the shared memory switching device 402 supports per-output port/per-CoS queuing (at a minimum), for a small (<16) set of classes.

2. Assume the shared memory switching device 402 and the ingress TMs 404 have per-output port/per-CoS queues 414 and 420 that are serviced in FIFO order.

3. Assume that the shared memory switching device 402 sends a backpressure indication 424 (e.g., backward congestion notification 424) to one or more input port VOQ schedulers 418 in the event that one of their per-output port/per-CoS queues 414 becomes congested.

4. Assume that the per-CoS switching fabric 412 lacks a per-packet DE indication mechanism or a DE-aware backpressure indication mechanism.

5. Assume that there is an ingress TM 404 on each fabric input port 408 of the shared memory switching device 402. And, assume each ingress TM supports a VOQ system 418 with per-fabric output port/per-CoS queues 420 that correspond directly with a respective output queue 414 in the shared memory switching device 402.

6. Assume that the backpressure indications 424 identify the input port VOQ 420 that is associated with (i.e., transmitting towards) the respective congested output queue 414 located in the shared memory switching device 402.

7. Assume that the backpressure indications 424 from the shared memory switching device 402 are fair per-input port/per-CoS even though scheduler weights for each VOQ scheduler 418 could be configured individually for each ingress TM 404.

8. Assume that a feasible matrix of committed traffic (CIR) per-input/output/CoS set is established. Thus, the traffic aggregates entering each VOQ 420 can be rate metered, and in the event that the traffic aggregate exceeds its committed rate, some packets can be marked discard-eligible (e.g., by Internet Protocol Differentiated Services Code Point (IP DSCP), or by internal tag) in a way which is visible to the VOQ 420, but not to the shared memory switching device 402 (see steps 502, 504 and 506 in FIG. 5).

9. Assume that whenever a switch output port/CoS queue 414 starts to become congested, backpressure indications 424 are sent to each VOQ scheduler 418 that services a VOQ 420 which is submitting traffic to that queue 414. The backpressure indications 424 have a probability proportional to the rate of traffic submitted by each VOQ scheduler 418 in relation to the total traffic in that output port/CoS queue 414, thereby providing a roughly fair backpressure per-input port/per-CoS 414. The ingress TMs 404 which distinguish between DE and committed traffic in accordance with the present solution can then reduce the DE transmission rate without otherwise slowing down the VOQ service rate (see steps 508 and 510 in FIG. 5).

If the ingress TMs 404 support the DE-aware active queue management (AQM) in accordance with the present solution, then when backpressure notifications 424 of early congestion in the shared memory switching device 402 are delivered, the ingress TMs 404 (in particular the VOQ scheduler(s) 418) which are transmitting within their committed rate do not need to reduce their transmission rate. This is based on the theory that the fabric congestion is caused by DE traffic that is received from one or more of the other ingress TMs 404. However, the ingress TMs 404 (in particular the VOQ scheduler(s) 418) which are transmitting in excess of their committed rates should reduce their transmission rate by discarding some or all of the DE traffic (see steps 508 and 510 in FIG. 5 and FIGS. 6-7). In fact, these VOQ schedulers 418 should continue to discard some fraction of DE traffic when under backpressure, even if they are underutilized, because if they transmit at their fair service rate as defined by a fabric's backpressure response protocol, it may preclude other VOQ scheduler(s) 418 on other input ports from sending at their committed rates, or it may increase the queueing latency of the other VOQ scheduler(s) 418 because they would also be required to respond to the persistent backpressure.

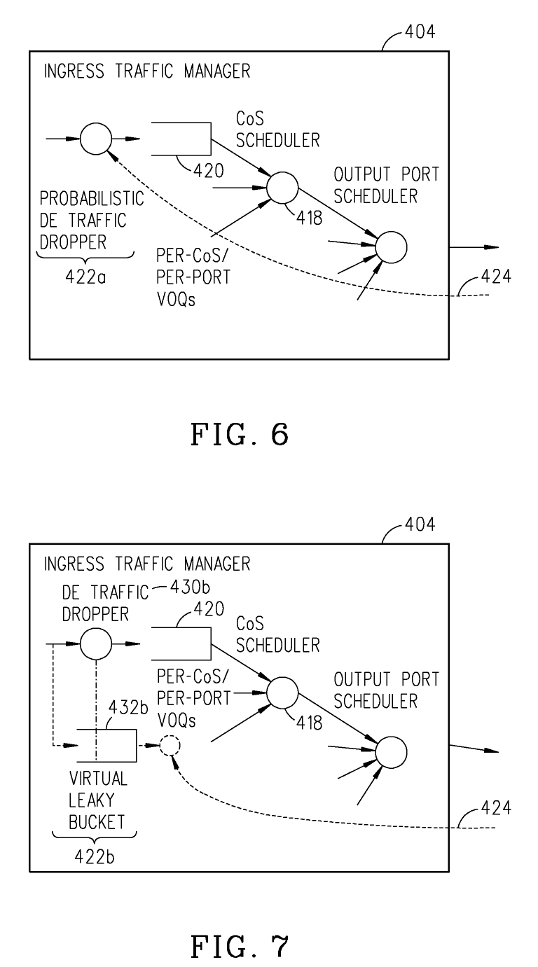

In the present solution, the precise discard mechanism 422 that the ingress TMs 404 which are under backpressure can use to reduce the DE traffic transmission rate can depend on a desired fairness policy for excess (DE) traffic service within the fabric switching system 400. Two exemplary discard mechanisms 422 include:
Probabilistic discard of a fraction of DE traffic (see the discussion that is related to the ingress TM 404 shown in FIG. 6).
Probabilistic discard of DE traffic based on thresholds of a virtual leaky bucket (see the discussion that is related to the ingress TM 404 shown in FIG. 7).

Whichever specific discard mechanism 422 is selected, it should follow these constraints:

1. Sufficient DE traffic should be discarded at any instance such that the total transmission rate of the pressured VOQ scheduler 418 from the indicated VOQ 420 is (substantially) less than that defined by the fabric's backpressure response protocol (assuming fair backpressure indications 424 are sent to the ingress TMs 404).

2. The rate of DE traffic transmitted out of the pressured VOQ scheduler 418 from the indicated VOQ 420 should be increased gradually after it has been reduced due to backpressure, so that the queue occupancies in the fabric switching system 400 can stabilize and so that oscillating congestion in the per-CoS switching fabric 412 can be avoided. This is true even if the affected VOQ scheduler 418 is otherwise idle.

3. The changes in the DE traffic transmission rate due to an increase or decrease in the DE discard rate/probability should occur no sooner than are defined by the increase/decrease reaction intervals which are a function of the round-trip latency within the fabric switching system 400.

4. The transmission rate by back-pressured VOQ schedulers 418 of indicated VOQs 420 with significant DE traffic should be decreased by more than the rate defined by the fabric's backpressure response protocol such that the non-pressured VOQ schedulers 418 at other input ports 408 do not have to reduce their transmission rates below their committed rates. In particular, the DE discard mechanism 422 should reduce the rate of DE transmission quickly enough at the onset of fabric congestion so that severe fabric congestion never occurs, and the other VOQ scheduler(s) 418 are not required to reduce their transmission rates, except perhaps for short intervals, which induce neither significant queueing latency nor loss.

Referring to FIG. 6, there is a block diagram of an exemplary ingress TM 404 which has a discard mechanism 422a (in particular a probabilistic DE traffic dropper 422a) that could be used to implement method 500 in accordance with a first embodiment of the present invention. Upon receipt of a backpressure indication 424 by a VOQ scheduler 418 for an indicated VOQ 420, the probabilistic DE traffic dropper 422a sets a discard probability to a predetermined initial value that is greater than zero where the discard probability indicates the fraction of the DE packets to be discarded so as to reduce the transmission rate of the traffic aggregate to the shared memory switching device 402. If the backpressure persists, then the probabilistic DE traffic dropper 422a increases the discard probability a predefined amount at a predefined increase interval (and policy) until the discard probability reaches a value of one in which case all of the DE packets are discarded to reduce the transmission rate of the traffic aggregate to the shared memory switching device 402. As the backpressure is relieved, the probabilistic DE traffic dropper 422a decreases the discard probability a predefined amount at a predefined decrease interval (and policy) until the discard probability reaches a value of zero in which case none of the DE packets would be discarded to reduce the transmission rate of the traffic aggregate to the shared memory switching device 402.

As can be seen, when the shared memory switching device 402 is congested then each back-pressured ingress TM 404 and in particular their probabilistic DE traffic dropper 422a addresses that congestion by setting or following these parameters:
The initial DE discard probability at the arrival of the first backpressure indication 424.
The discard probability increase interval.
The discard probability decrease interval.
The discard probability increase factor: either a constant factor (e.g., 1/4), or a multiplicative factor (e.g., by multiplying the current DE packet transmit probability by a ratio such as 3/4, and subtracting this value from 1) (note: a constant factor leads to an AIAD system, while a multiplicative factor leads to an AIMD system).
The discard probability decrease factor, which should be a constant factor per-decrease interval (e.g., 1/8) to promote stability.

Note 1: The values of these parameters should be tuned for the particular per-CoS switching fabric 412 that is used within the shared memory switching device 402. For example, the values of these parameters could be tuned based on the round-trip latency, the backpressure response protocol, and the number of input ports 408 within the particular shared memory switching device 402.

Note 2: This embodiment does not enforce fairness of excess traffic across the fabric input ports 408 under fabric congestion. Thus, the rate of excess traffic from each VOQ scheduler 418 remains proportional to the rate of excess traffic that was submitted to that particular VOQ scheduler 418 for transmission.

Referring to FIG. 7, there is a block diagram of an exemplary ingress TM 404 which has a discard mechanism 422b (in particular a DE traffic dropper 430b and a virtual leaky bucket 432b) that could be used to implement method 500 in accordance with a second embodiment of the present invention. Upon receipt of a backpressure indication 424, the DE traffic dropper 430b and the virtual leaky bucket 432b reduce a virtual leaky bucket service rate by a predefined initial rate where the reduced virtual leaky bucket service rate controls the fraction of the DE packets to be discarded so as to reduce the transmission rate of the traffic aggregate to the shared memory switching device 402 (note: the virtual leaky bucket 432b would be serviced at the regular VOQ service rate when the shared memory switching device 402 is not congested). If the backpressure persists, then the DE traffic dropper 430b and the virtual leaky bucket 432b decrease the virtual leaky bucket service rate a predefined amount at a predefined decrease interval (and policy) until the virtual leaky bucket service rate reaches a minimum rate in which case all of the DE packets are discarded to reduce the transmission rate of the traffic aggregate to the shared memory switching device 402 (note: the virtual leaky bucket 432b can do this by implementing some form of AQM for DE traffic which is related to the occupancy of the DE traffic that can be for example a threshold technique or some derivative of a Random Early Discard (RED) technique). As the backpressure is relieved, the DE traffic dropper 430b and the virtual leaky bucket 432b increase the virtual leaky bucket service rate a predefined amount at a predefined increase interval (and policy) until the virtual leaky bucket service rate reaches a maximum rate in which case none of the DE packets are discarded to reduce the transmission rate of the traffic aggregate to the shared memory switching device 402.

As can be seen, when the shared memory switching device 402 is congested then each back-pressured ingress TM 404 and in particular their DE traffic dropper 430b and virtual leaky bucket 432b addresses that congestion by setting or following these parameters:
The initial virtual leaky bucket service rate decrease factor at the arrival of the first backpressure indication 424.
The virtual leaky bucket service rate decrease interval.
The virtual leaky bucket service rate increase interval.
The virtual leaky bucket service rate decrease factor: either a constant factor (e.g., 1/4), or a multiplicative factor (e.g., by multiplying the current service rate by a ratio such as 1/4) (note: a constant service rate decrease factor leads to an AIAD system, while a multiplicative service rate decrease factor leads to an AIMD system).
The virtual leaky bucket service rate increase factor, which should be a constant factor per-increase interval (e.g., 1/8) to promote stability.

Note 1: The values of these parameters should be tuned for the particular per-CoS switching fabric 412 that is used within the shared memory switching device 402. For example, the values of these parameters could be tuned based on the round-trip latency, the backpressure response protocol, and the number of input ports 408 within the particular shared memory switching device 402.

Note 2: This embodiment does enforce fairness of excess traffic across fabric input ports 408 under fabric congestion.

Note 3: The virtual leaky bucket service rate does not affect the service rate of the VOQ scheduler 418 but instead it is only used to trigger DE traffic discard.

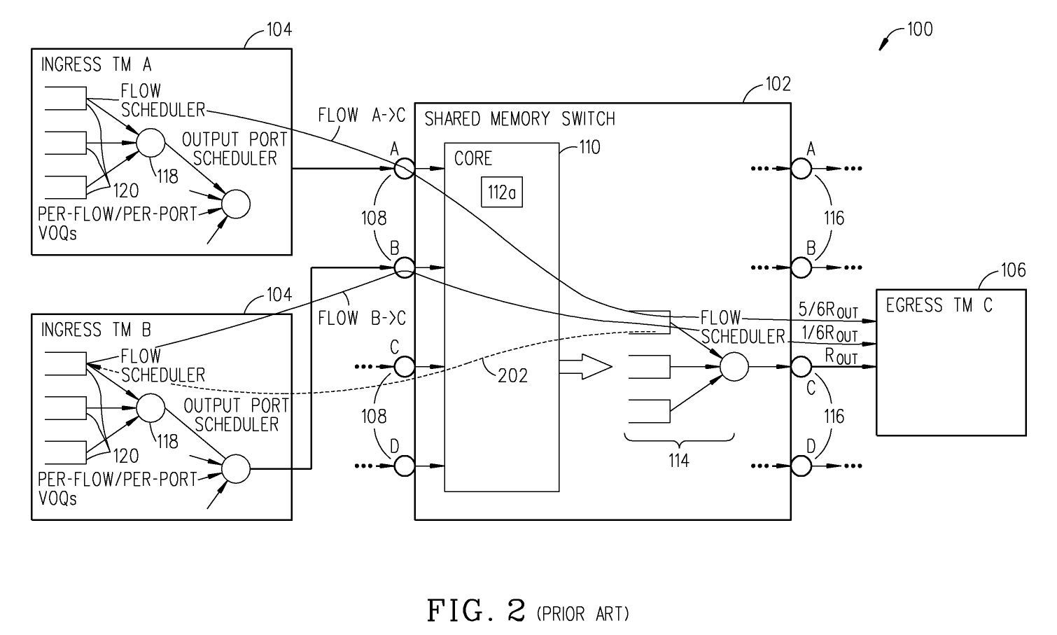

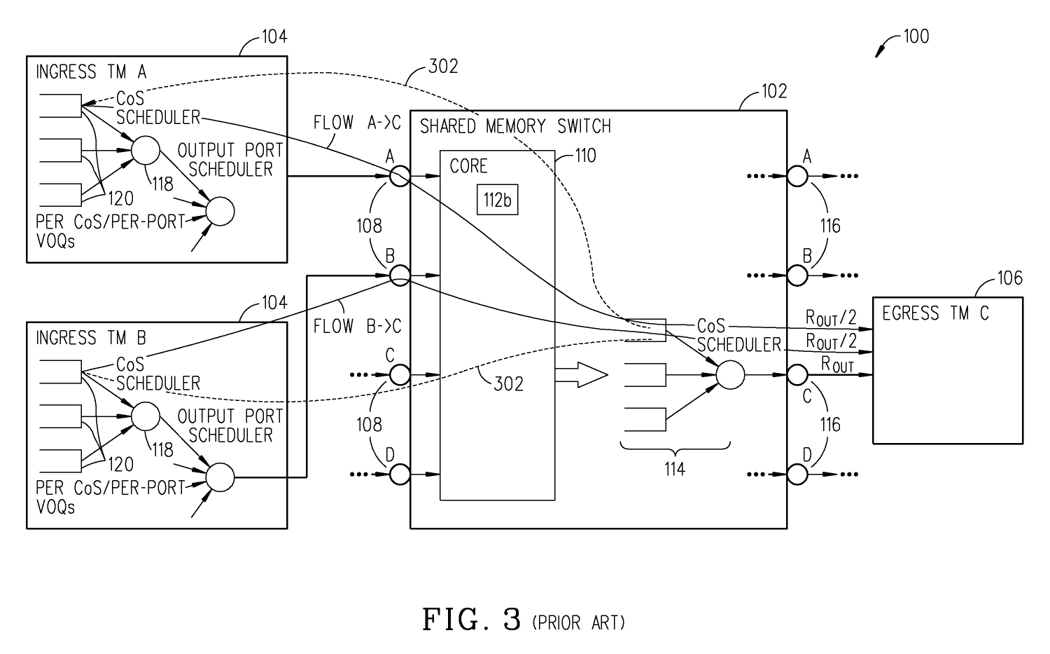

From the foregoing, it should be appreciated that the present solution allows per-CoS switching devices 402 with fair backpressure support to be used in fabric switching systems 400 that require the equivalent of non-fair scheduling for input/output/CoS traffic aggregates. Such a fabric architecture overcomes the cost and scalability limitations of the traditional per-flow switching fabrics (see FIG. 2). Plus, it should be appreciated that the present solution can be implemented so as to compatible with emerging fabric standards (e.g., see the Virtual Bridged Local Area Networks—Amendment 7: Congestion Management, Draft 0.1, IEEE P802.1au, Sep. 29, 2006).

Although multiple embodiments of the present invention have been illustrated in the accompanying Drawings and described in the foregoing Detailed Description, it should be understood that the invention is not limited to the disclosed embodiments, but instead is also capable of numerous rearrangements, modifications and substitutions without departing from the spirit of the invention as set forth and defined by the following claims.

1. A traffic manager comprising:
a virtual output queue scheduler with a discard mechanism and a plurality of per-fabric output port/per-Class of Service queues that:
receives a traffic aggregate;
rate monitors the traffic aggregate;
marks a portion of packets in the traffic aggregate as discard-eligible packets whenever the monitored rate of the traffic aggregate exceeds a committed rate,
transmits packets and the discard-eligible packets within the traffic aggregate at a transmission rate that is greater than the committed rate towards a per-Class of Service switching fabric in a shared memory switching device; and
upon receiving a backpressure indication from the shared memory switching device, discards at least a fraction of the discard-eligible packets within the traffic aggregate to reduce the transmission rate of the traffic aggregate to the shared memory switching device.

2. The traffic manager of claim 1, wherein said discard mechanism discards the discard-eligible packets by:
setting a discard probability to an initial value that is greater than zero upon receipt of the backpressure indication where the discard probability indicates the fraction of the discard-eligible packets to be discarded to reduce the transmission rate of the traffic aggregate to the shared memory switching device:
if backpressure persists, then increasing the discard probability a predefined amount at a predefined increase interval until the discard probability reaches a value of one in which case all of the discard-eligible packets are discarded to reduce the transmission rate of the traffic aggregate to the shared memory switching device; and
if backpressure reduces then decreasing the discard probability a predefined amount at a predefined decrease interval until the discard probability reaches a value of zero in which case none of the discard-eligible packets would be discarded to reduce the transmission rate of the traffic aggregate to the shared memory switching device.

3. The traffic manager of claim 2, wherein said discard mechanism increases the discard probability by a constant factor during each predefined increase interval until the discard probability reaches the value of one in which case all of the discard-eligible packets are discarded to reduce the transmission rate of the traffic aggregate to the shared memory switching device.

4. The traffic manager of claim 2, wherein said discard mechanism increases the discard probability by a multiplicative factor during each predefined increase interval until the discard probability reaches the value of one in which case all of the discard-eligible packets are discarded to reduce the transmission rate of the traffic aggregate to the shared memory switching device.

5. The traffic manager of claim 2, wherein said discard mechanism decreases the discard probability by a constant factor during each predefined decrease interval until the discard probability reaches the value of zero in which case none of the discard-eligible packets are discarded to reduce the transmission rate of the traffic aggregate to the shared memory switching device.

6. The traffic manager of claim 2, wherein said discard mechanism sets the initial value of the discard probability, the predefined increase interval and the predefined decrease interval based on a round-trip latency, a backpressure protocol and a number of fabric ports in the shared memory switching device.

7. The traffic manager of claim 1, wherein said discard mechanism further includes a virtual leaky bucket that enables the discarding of the discard-eligible packets by:
reducing a virtual leaky bucket service rate by an initial rate upon receipt of the backpressure indication where the reduced virtual leaky bucket service rate controls the fraction of the discard-eligible packets to be discarded to reduce the transmission rate of the traffic aggregate to the shared memory switching device;
if backpressure persists, then decreasing the virtual leaky bucket service rate a predefined amount at a predefined decrease interval until the virtual leaky bucket service rate reaches a minimum rate in which case all of the discard-eligible packets are discarded to reduce the transmission rate of the traffic aggregate to the shared memory switching device; and
if backpressure reduces, then increasing the virtual leaky bucket service rate a predefined amount at a predefined increase interval until the virtual leaky bucket service rate reaches a maximum rate in which case none of the discard-eligible packets are discarded to reduce the transmission rate of the traffic aggregate to the shared memory switching device.

8. The traffic manager of claim 7, wherein said discard mechanism decreases the virtual leaky bucket service rate by a constant factor during each predefined decrease interval until the virtual leaky bucket service rate reaches a minimum rate in which case all of the discard-eligible packets are discarded to reduce the transmission rate of the traffic aggregate to the shared memory switching device.

9. The traffic manager of claim 7, wherein said discard mechanism decreases the virtual leaky bucket service rate by a multiplicative factor during each predefined decrease interval until the virtual leaky bucket service rate reaches a minimum rate in which case all of the discard-eligible packets are discarded to reduce the transmission rate of the traffic aggregate to the shared memory switching device.

10. The traffic manager of claim 7, wherein said discard mechanism increases the virtual leaky bucket service rate at a constant rate during each predefined increase interval until the virtual leaky bucket service rate reaches the maximum rate in which case none of the discard-eligible packets are discarded to reduce the transmission rate of the traffic aggregate to the shared memory switching device.

11. The traffic manager of claim 7, wherein said discard mechanism sets the initial value of the virtual leaky bucket service rate, the predefined increase interval and the predefined decrease interval based on a round-trip latency, a backpressure protocol and a number of fabric ports in the shared memory switching device.

12. A method for performing an active queue management of discard-eligible traffic within a traffic manager which has a virtual output queue scheduler, a discard mechanism and a plurality of per-fabric output port/per-Class of Service queues, said method comprising the steps of:
receiving a traffic aggregate;
rate monitoring the traffic aggregate;
marking a portion of packets in the traffic aggregate as discard-eligible packets whenever the monitored rate of the traffic aggregate exceeds a committed rate;
transmitting packets and the discard-eligible packets within the traffic aggregate at a transmission rate that is greater than the committed rate towards per-Class of Service switching fabric in a shared memory switching device; and
upon receiving a backpressure indication from the fabric switching system discarding at least a fraction of the discard-eligible packets within the traffic aggregate to reduce the transmission rate of the traffic aggregate to the shared memory switching device.

13. The method of claim 12, wherein said discarding step includes the following steps:
setting a discard probability to an initial value that is greater than zero upon receipt of the backpressure indication where the discard probability indicates the fraction of the discard-eligible packets to be discarded to reduce the transmission rate of the traffic aggregate to the shared memory switching device;
if backpressure persists, increasing the discard probability a predefined amount at a predefined increase interval until the discard probability reaches a value of one in which case all of the discard-eligible packets are discarded to reduce the transmission rate of the traffic aggregate to the shared memory switching device; and
if backpressure reduces, decreasing the discard probability a predefined amount at a predefined decrease interval until the discard probability reaches a value of zero in which case none of the discard-eligible packets would be discarded to reduce the transmission rate of the traffic aggregate to the shared memory switching device.

14. The method of claim 13, wherein said increasing step further includes a step of increasing the discard probability by a constant factor during each predefined increase interval until the discard probability reaches the value of one in which case all of the discard-eligible packets are discarded to reduce the transmission rate of the traffic aggregate to the shared memory switching device.

15. The method of claim 13, wherein said increasing step further includes a step of increasing the discard probability by a multiplicative factor during each predefined increase interval until the discard probability reaches the value of one in which case all of the discard-eligible packets are discarded to reduce the transmission rate of the traffic aggregate to the shared memory switching device.

16. The method of claim 13, wherein said decreasing step further includes a step of decreasing the discard probability by a constant factor during each predefined decrease interval until the discard probability reaches the value of zero in which case none of the discard-eligible packets are discarded to reduce the transmission rate of the traffic aggregate to the shared memory switching device.

17. The method of claim 12, wherein said discard mechanism further includes a virtual leaky bucket and said discarding step includes the following steps:
reducing a virtual leaky bucket service rate by an initial rate upon receipt of the backpressure indication where the reduced virtual leaky bucket service rate controls the fraction of the discard-eligible packets to be discarded to reduce the transmission rate of the traffic aggregate to the shared memory switching device;
if backpressure persists, decreasing the virtual leaky bucket service rate a predefined amount at a predefined decrease interval until the virtual leaky bucket service rate reaches a minimum rate in which case all of the discard-eligible packets are discarded to reduce the transmission rate of the traffic aggregate to the shared memory switching device; and
if backpressure reduces, increasing the virtual leaky bucket service rate a predefined amount at a predefined increase interval until the virtual leaky bucket service rate reaches a maximum rate in which case none of the discard-eligible packets are discarded to reduce the transmission rate of the traffic aggregate to the shared memory switching device.

18. The method of claim 17, wherein said decreasing step further includes a step of decreasing the virtual leaky bucket service rate by a constant factor during each predefined decrease interval until the virtual leaky bucket service rate reaches a minimum rate in which case all of the discard-eligible packets are discarded to reduce the transmission rate of the traffic aggregate to the shared memory switching device.

19. The method of claim 17, wherein said decreasing step further includes a step of decreasing the virtual leaky bucket service rate by a multiplicative factor during each predefined decrease interval until the virtual leaky bucket service rate reaches a minimum rate in which case all of the discard-eligible packets are discarded to reduce the transmission rate of the traffic aggregate to the shared memory switching device.

20. The method of claim 17, wherein said increasing step further includes a step of increasing the virtual leaky bucket service rate at a constant rate during each predefined increase interval until the virtual leaky bucket service rate reaches the maximum rate in which case none of the discard-eligible packets are discarded to reduce the transmission rate of the traffic aggregate to the shared memory switching device.

21. A fabric switching system, comprising:
a shared memory switching device having a per-Class of Service switching fabric; and
a plurality of traffic managers, wherein each traffic manager has a virtual output queue scheduler, a discard mechanism and a plurality of per-fabric output port/per-Class of Service queues, and wherein each traffic manager functions to:
receive a traffic aggregate;
rate monitor the traffic aggregate;
mark a portion of packets in the traffic aggregate as discard-eligible packets whenever the monitored rate of the traffic aggregate exceeds a committed rate;
transmit packets and the discard-eligible packets within the traffic aggregate at a transmission rate that is greater than the committed rate towards the shared memory switching device; and
upon receiving a backpressure indication from the fabric switching system, discard at least a fraction of the discard-eligible packets within the traffic aggregate to reduce the transmission rate of the traffic aggregate to the shared memory switching device.

22. The fabric switching system of claim 21, wherein each discard mechanism discards the discard-eligible packets by:
setting a discard probability to an initial value that is greater than zero upon receipt of the backpressure indication where the discard probability indicates the fraction of the discard-eligible packets to be discarded to reduce the transmission rate of the traffic aggregate to the shared memory switching device;
if backpressure persists, then increasing the discard probability a predefined amount at a predefined increase interval until the discard probability reaches a value of one in which case all of the discard-eligible packets are discarded to reduce the transmission rate of the traffic aggregate to the shared memory switching device; and
if backpressure reduces, then decreasing the discard probability a predefined amount at a predefined decrease interval until the discard probability reaches a value of zero in which case none of the discard-eligible packets would be discarded to reduce the transmission rate of the traffic aggregate to the shared memory switching device.

23. The fabric switching system of claim 21, wherein each discard mechanism further includes a virtual leaky buck and discards the discard-eligible packets by:
reducing a virtual leaky bucket service rate by an initial rate upon receipt of the backpressure indication where the reduced virtual leaky bucket service rate controls the fraction of the discard-eligible packets to be discarded to reduce the transmission rate of the traffic aggregate to the shared memory switching device;
if backpressure persists, then decreasing the virtual leaky bucket service rate a predefined amount at a predefined decrease interval until the virtual leaky bucket service rate reaches a minimum rate in which case all of the discard-eligible packets are discarded to reduce the transmission rate of the traffic aggregate to the shared memory switching device; and
if backpressure reduces, then increasing the virtual leaky bucket service rate a predefined amount at a predefined increase interval until the virtual leaky bucket service rate reaches a maximum rate in which case none of the discard-eligible packets are discarded to reduce the transmission rate of the traffic aggregate to the shared memory switching device.
